(19) United States
(12) Patent Application Publication
(10) Pub. No.: US 2019/0282444 A1
(43) Pub. Date: Sep. 19, 2019

(54) View Window Medication Packaging

(71) Applicant: Mylan Inc., Canonsburg, PA (US)

(72) Inventors: JoAnna Terhune, Pittsburgh, PA (US); Michael Scouvart, Venetia, PA (US); Anthony Mauro, Washington, PA (US)

(21) Appl. No.: 16/318,728

(22) PCT Filed: Jul. 18, 2017
(86) PCT No.: PCT/US17/42511

§ 371 Date: Jan. 18, 2019

Related U.S. Application Data
(60) Provisional application No. 62/363,885, filed on Jul. 19, 2016.

(51) Int. Cl. A61J 1/03; B65D 25/54

(52) U.S. Cl. CPC A61J 1/03; B65D 25/54

(57) ABSTRACT

A medication container includes a body having a wall that defines a cavity configured for disposal of medication. The wall defines a gap. Indicia is disposed with gap. The indicia is configured to facilitate visualization of the medication disposed within the cavity. Systems and methods of use are disclosed.

### TECHNICAL FIELD

The present disclosure generally relates to medicament packaging and more particularly to a dispensing device and system, and a method for treatment of a medical condition.

### BACKGROUND

Pharmaceuticals including prescription and/or non-prescription medication, and so-called nutraceuticals can be administered in connection with a medication regimen for nutritional, therapeutic and/or illness treatment. Such pharmaceuticals and/or nutraceuticals are often dispensed in substantially opaque and/or non-translucent medication containers, for example, dark brown pill bottles. These types of pill bottles typically filter light to protect pharmaceuticals and/or nutraceuticals that are non-desirably affected when subjected to light. In some cases, however, such pill bottles may prevent inspection of the quantity, shape and type of medication within the pill bottle, as well making it difficult to confirm tampering of the medication. This disclosure describes an improvement over these prior technologies.

### SUMMARY

In one embodiment, a medication container is provided. The medication container includes a body having a wall that defines a cavity configured for disposal of medication. The wall also defines a gap. Indicia is disposed with gap. The indicia is configured to facilitate visualization of the medication disposed within the cavity. Systems and methods of use are disclosed.

### BRIEF DESCRIPTION OF THE DRAWINGS

The present disclosure will become more readily apparent from the specific description accompanied by the following drawings, in which:

FIG. 1 is a perspective view of components of one embodiment of a system in accordance with the principles of the present disclosure;

FIG. 2 is an enlarged detail view of components of the system shown in FIG. 1; and

FIG. 3 is a side view of components of one embodiment of a system in accordance with the principles of the present disclosure.

### DETAILED DESCRIPTION

The exemplary embodiments of a medicament packaging system, such as, for example, a medicine container and related methods of use disclosed are discussed in terms of dispensing devices for the treatment of various diseases, illness and/or ailments and more particularly, in terms of a medicament dispensing device and system. In some embodiments, the medicament packaging system provides medication and a method for treatment of a medical condition.

In some embodiments, the medicament packaging system includes a container that provides indicia, such as, for example, a window to facilitate visualization, monitoring, identification, inspection and/or confirmation of quantity, amount, volume, shape, color, size, type and/or tampering of medication within the container. In some embodiments, the indicia includes a translucent or transparent band disposed with a wall surface of the container. In some embodiments, the container defines a longitudinal axis and the indicia includes a longitudinal translucent or transparent band connected with the wall surface. In some embodiments, the indicia includes a translucent or transparent band disposed with a full axial length of the wall surface of the container. In some embodiments, the indicia includes a translucent or transparent band disposed with only a portion of the full axial length of the wall surface of the container. In some embodiments, the container includes a top surface and a bottom surface connected by the wall surface. In some embodiments, the indicia includes the top surface and/or the bottom surface having an annular viewing window. In some embodiments, the indicia includes the bottom surface being clear and/or translucent. In some embodiments, the indicia includes multiple small viewing windows axially disposed along the wall surface of the container. In some embodiments, the indicia includes one or a plurality of translucent or transparent windows, for example, round portholes and/or alphanumeric characters, for example, the characters M-Y-L-A-N disposed in various orientations, such as, axial, angular and/or transverse relative to a longitudinal axis of the container.

In some embodiments, the translucent or transparent indicia includes a narrow band distinguished and/or contrasted from an adjacent surface of the container. In some embodiments, the translucent or transparent indicia include parallel bands or spaced apart bands. In some embodiments, the translucent or transparent indicia includes a band differing in color, structure, chemical properties, spectral properties, photochemical properties, material and/or texture from an adjacent surface of the container. In some embodiments, all or only a portion of the translucent or transparent indicia includes a colored surface and/or color that is configured to reflect a frequency of a wavelength that reflects from a surface of the container. In some embodiments, all or only a portion of the translucent or transparent indicia includes a colored surface and/or color that is configured to resist and/or prevent passage of ultraviolet (UV) light. In some embodiments, the medicament packaging system is employed with a method of manufacture of a container having a container wall surface of a first material and a translucent or transparent indicia of a second material for packaging pharmaceuticals.

In some embodiments, the medicament packaging system includes a container having indicia, such as, for example, a view stripe. In some embodiments, the medicament packaging system is employed with a method of manufacture of a container having a view stripe for packaging pharmaceuticals. In some embodiments, the view stripe includes a transparent or translucent stripe extending generally parallel to a vertical axis of the container. In some embodiments, the view stripe extends from approximately a top of the container to approximately a bottom of the container. In some embodiments, the container is configured to conform to requirements of current medication bottle manufacture, such as, for example, to protect the medicine from external factors, such as, for example, light and/or oxygen.

In some embodiments, the medicament packaging system includes a container including a wall surface having a first color and indicia comprising a second color. In some embodiments, the container includes a blue bottle resin, such as, for example, a high density polyethylene. In some embodiments, the view stripe includes a polyethylene terephthalate (PET) or polypropylene material. In some embodiments, the view stripe includes a translucent material to facilitate viewing of medication disposed with the container. In some embodiments, the first color is blue and the second color is yellow.

In some embodiments, the indicia is translucent or transparent and includes a color that is configured to block out visible or invisible light wavelengths from an interior cavity of the container. In some embodiments, the indicia color is yellow. In some embodiments, the indicia color is blue. In some embodiments, the indicia color is amber. In some embodiments, the indicia color is configured to match that of standard pharmacy vials to carry over a level of patient familiarity. In some embodiments, the indicia color is configured to facilitate viewing of medication. In some embodiments, the stripe includes a film and/or coating. In some embodiments, the coating is configured to block out visible or invisible light wavelengths.

In some embodiments, the medicament packaging system includes a container having a 75 cc capacity. In some embodiments, the medicament packaging system includes a container having a capacity in a range of 30 cc to 1000 cc. In some embodiments, the medicament packaging system includes various sized container capacities. In some embodiments, the indicia include a selected width. In some embodiments, the width is determined by a size of the container. In some embodiments, the width is determined by a label size disposed with the container. In some embodiments, the width equals one half inch when disposed with a 75 cc container.

In some embodiments, the container is configured for solid oral dosage forms. In some embodiments, the container includes a high density polyethylene (HDPE) bottle. In some embodiments, the container is subject to analysis including humidity, barrier protection, spectral transmittance and/or weight compliance to conform to requirements of selected medication bottle manufacture, such as, for example, to protect the medicine from external factors, such as, for example, light and/or oxygen. In some embodiments, the analysis includes observing spectral transmission for plastic containers intended for oral or topical administration that does not exceed 10% at any wavelength in the range 290-450 nanometers. In some embodiments, the analysis includes infrared spectroscopy. In some embodiments, the analysis includes differential scanning calorimetry.

In some embodiments, the container analysis includes establishing a worst-case potential leachables profile in a manner that facilitates leachable studies, the development of leachables specifications and acceptance criteria, and/or the safety evaluation/qualification of potential and actual leachables. In some embodiments, extractables are organic and inorganic chemical entities that can be released from a medicament packaging system, packaging component, or packaging material of construction and into an extraction solvent under laboratory conditions. In some embodiments, laboratory conditions, such as, for example, solvent, temperature and/or stoichiometry may accelerate or exaggerate the normal conditions of storage and use for a packaged dosage form. In some embodiments, extractables themselves, or substances derived from extractables, have the potential to leach into a drug product under normal conditions of storage and use and become leachables. In some embodiments, extractables are potential leachables.

The present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

As used in the specification and including the appended claims, “treating” or “treatment” of a disease or condition may include administering one or more medications to a patient (human or other mammal). Alleviation can occur prior to signs or symptoms of the disease or condition appearing, as well as after their appearance. Thus, treating or treatment includes preventing or prevention of disease or undesirable condition (e.g., preventing the disease from occurring in a patient, who may be predisposed to the disease but has not yet been diagnosed as having it). In addition, treating or treatment does not require complete alleviation of signs or symptoms, does not require a cure, and specifically includes procedures that have only a marginal effect on the patient. Treatment can include inhibiting the disease, e.g., arresting its development, or relieving the disease, e.g., causing regression of the disease. For example, treatment includes, but is not limited to, reducing acute or chronic inflammation, inducing an anti-platelet effect, reducing hypertension, and lowering cholesterol.

In some embodiments, a biologically-active substance includes any substance or substances comprising a medicament, medication or drug including an active therapeutic substance, metabolite, hormone, steroid, vitamin, fatty acid, amino acid, sugar, carbohydrate, polypeptide or mineral. In some embodiments, a biologically-active substance includes any substance used for treatment, prevention, diagnosis, cure or mitigation of disease or illness. In some embodiments, a biologically-active substance includes any substance that affects anatomical structure or physiological function. In some embodiments, a biologically-active substance includes any substance that alters the impact of external influences on an animal, or metabolite thereof. In some embodiments, a complex dosing regimen includes a systematic administration of multiple dosage units at designated times during the day. In some embodiments, a dose includes each individual release of substance into body tissue.

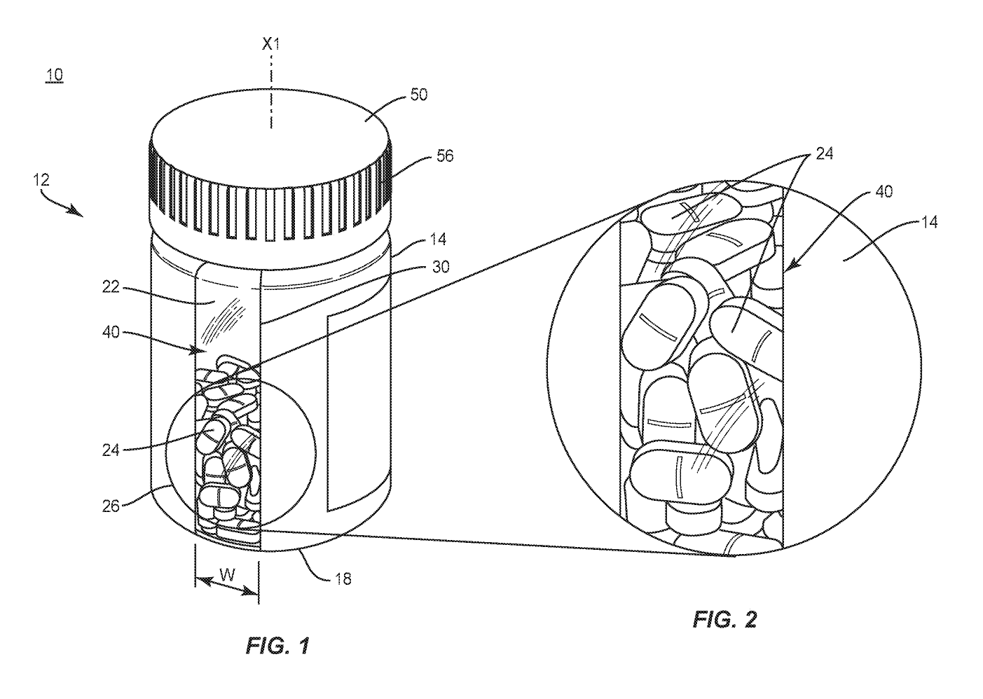

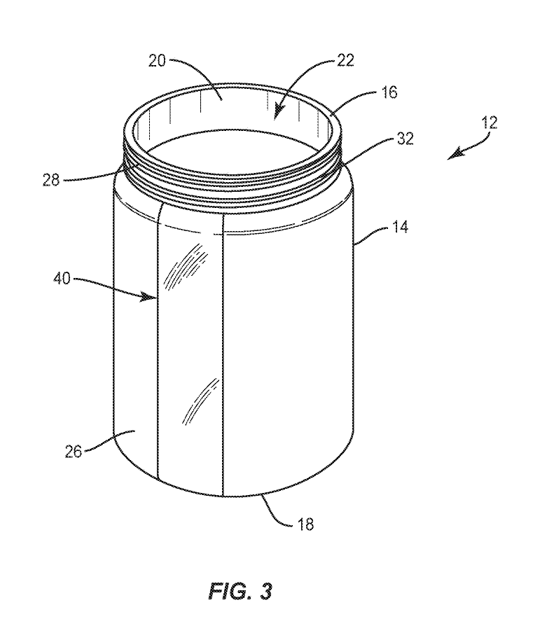

The following discussion includes a description of a medicament dispensing system including a medicament dispensing bottle, related components and methods of employing the medicament dispensing system. Alternate embodiments are disclosed. Reference is made in detail to the exemplary embodiments of the present disclosure, which are illustrated in the accompanying figures. Turning to FIGS. 1-3, there are illustrated components of a medicament dispensing system 10.

The components of medicament dispensing system 10, individually or collectively, can be fabricated from materials suitable for storage and dispensing of medication. In some embodiments, such materials include metals, ceramics, synthetic polymers such as thermoplastics, semi-rigid and rigid materials, elastomers, fabric and/or their composites. Various components of medicament dispensing system 10 may have material composites, including the above materials, to achieve various desired characteristics such as strength, rigidity, elasticity, compliance, and durability. The components of medicament dispensing system 10, individually or collectively, may also be fabricated from a heterogeneous material such as a combination of two or more of the above-described materials. The components of medicament dispensing system 10 may be monolithically formed, integrally connected or include fastening elements and/or instruments, as described herein.

Medicament dispensing system 10 includes a medication container, such as, for example, a bottle 12. Bottle 12 includes a body 14. Body 14 includes an opening 16 and a base 18. In some embodiments, body 14 includes a circular cross-section. In some embodiments, body 14 may include cross-section shapes, such as, for example, partially cylindrical, oval, rectangular, polygonal, irregular, tapered, offset, staggered, uniform and non-uniform.

Body 14 includes a surface 20 that defines a cavity 22. Cavity 22 is configured to receive, contain and store medication 24. In some embodiments, medication 24 includes oral solid dosage units, gel capsules or a liquid. In some embodiments, cavity 22 includes a 75 cc capacity. In some embodiments, cavity 22 includes a capacity in a range of 30 cc to 1000 cc. In some embodiments, cavity 22 includes various sized capacities.

Body 14 includes a surface 26 that is configured to facilitate gripping by a user to access medication 24 stored therein. In some embodiments, surface 26 may have alternate surface configurations, such as, for example, rough, arcuate, undulating, mesh, porous, semi-porous, dimpled and/or textured to facilitate gripping by a patient. In some embodiments surface 26 has various ergonomic qualities, such as, for example, rubberized inserts or grooves to conform to a user's grip.

In some embodiments, all or only a portion of a surface of body 14 is colored and/or includes a color. In some embodiments, the color of body 14 is configured to prevent ultraviolet light from degrading the potentially photosensitive medication 24 through photochemical reactions. In some embodiments, the color may include, such as, for example, orange, light brown, clear, blue, dark brown, green, and/or various opaque hues. In some embodiments, the color may include a quality of the surface of body 14 with respect to light reflected by the surface of body 14 and/or determined visually by measurement of hue, saturation, and brightness of the reflected light.

In some embodiments, body 14 is manufactured having a cavity, such as, for example, a gap 30. In some embodiments, gap 30 includes a width W. In some embodiments, width W is determined by a size of bottle 12. In some embodiments, width W is determined by a label size disposed with bottle 12. In some embodiments, width W measures a ½ inch when disposed with bottle 12 having a 75 cc capacity.

In some embodiments, all or only a portion of gap 30 is configured for disposal of indicia. In some embodiments, additional indicia may be disposed on surface 26 adjacent gap 30. In some embodiments, the indicia is configured to facilitate visualization, monitoring, identification, inspection and/or confirmation of quantity, amount, volume, shape, color, size, type, and/or tampering of medication 24 within cavity 22. In some embodiments, the indicia may include graphics. In some embodiments, a sticker containing the indicia may be adhered to a portion of body 14 and extend across gap 30.

In some embodiments, the indicia comprises a window and/or is translucent or transparent, and extends across gap 30. The translucent or transparent indicia may include, for example, a view stripe 40 that extends laterally across gap 30. Stripe 40 is disposed with gap 40. Stripe 40 is translucent and extends between opening 16 and a base 18 to facilitate viewing of medication 24 within cavity 22 between opening 16 and base 18. In some embodiments, stripe 40 extends axially along body 14 and parallel to an axis X1 of body 14. In some embodiments, stripe 40 may be disposed at alternate orientations, relative to axis X1, such as, for example, transverse, perpendicular and/or other angular orientations such as acute or obtuse, coaxial and/or may be offset or staggered along body 14. In some embodiments, stripe 40 is longitudinally disposed along all or only a portion of body 14. In some embodiments, bottle 12 is employed with a method of manufacture such that a wall surface of body 14 is fabricated from a first material, such as those material examples described herein, and the window and/or is translucent or transparent indicia is fabricated from a second material, such as those material examples described herein, for packaging pharmaceuticals. In some embodiments, bottle 12 is employed with a method of manufacture such that a wall surface of body 14 is monolithically formed with the window and/or is translucent or transparent indicia fabricated from a second material, such as those material examples described herein, for packaging pharmaceuticals. In some embodiments, stripe 40 is disposed with a full axial length of body 14 along surface 26. In some embodiments, stripe 40 is disposed with only a portion of the full axial length of body 14 along surface 26. In some embodiments, base 18 includes indicia comprising an annular viewing window. In some embodiments, base 18 includes indicia comprising a clear and/or translucent surface. In some embodiments, surface 26 includes indicia comprising multiple small viewing windows axially disposed along surface 26. In some embodiments, surface 26 includes indicia comprising multiple small viewing windows variously disposed along surface 26, for example, arcuate, circular, polygonal, staggered, offset, tapered and/or random. In some embodiments, surface 26 and/or base 18 includes indicia comprising one or a plurality of translucent or transparent windows, for example, round portholes and/or alphanumeric characters, for example, the characters M-Y-L-A-N disposed in various orientations, such as, axial, angular and/or transverse relative to a longitudinal axis of the container. In some embodiments, one or more of the translucent or transparent windows may have alternate configurations, such as, for example, round, V-shaped, W-shaped, oval, oblong, triangular, square, polygonal, irregular, uniform, non-uniform, offset, staggered, and/or tapered.

In some embodiments, all or only a portion of stripe 40 is colored and/or includes a color. In some embodiments, the color of stripe 40 is configured to prevent ultraviolet light from degrading the potentially photosensitive medication 24 through photochemical reactions. In some embodiments, the color of stripe 40 is configured to facilitate viewing of medication 24 inside bottle 12. In some embodiments, the color of stripe 40 is configured to allow visible light through for the medication 24 to be easily visible. In some embodiments, the color of stripe 40 may include, such as, for example, orange, light brown, clear, blue, dark brown, green, and/or various opaque hues. In some embodiments, the color may include a quality of the surface of body 14 with respect to light reflected by the surface of body 14 and/or determined visually by measurement of hue, saturation, and brightness of the reflected light.

In some embodiments, the color of stripe 40 is configured to block out visible or invisible light wavelengths. In some embodiments, the color of stripe 40 is yellow. In some embodiments, the color of stripe 40 is blue. In some embodiments, the color of stripe 40 is amber. In some embodiments, the color of stripe 40 is configured to match that of standard pharmacy vials to carry over a level of patient familiarity. In some embodiments, the color of stripe 40 is configured to facilitate viewing of the medication. In some embodiments, stripe 40 includes a film and/or coating configured to prevent ultraviolet light from degrading the potentially photosensitive medication 24 through photochemical reactions. In some embodiments, the coating is configured to block out visible or invisible light wavelengths.

In some embodiments, body 14 includes a neck portion 28. Neck portion 28 extends from body 14 and includes a surface 30. In some embodiments, surface 30 includes threads 32. In some embodiments, threads 32 may include a single thread turn or a plurality of discrete threads. In some embodiments, threads 32 comprise child-resistant features, such as, for example, a gap in threads 32 to correspond with a tab in the threads of a lid, as described herein.

In some embodiments, medicament dispensing system 10 includes a lid 50. Lid 50 includes an inner surface having threads engageable with threads 32. In some embodiments, lid 50 includes an outer surface 56 having ridges configured to facilitate gripping by a patient. In some embodiments, surface 56 may have alternate surface configurations, such as, for example, rough, arcuate, undulating, mesh, porous, semi-porous, dimpled and/or textured to facilitate gripping by a patient. In some embodiments, surface 56 includes indicia comprising an annular viewing window.

In some embodiments, lid 50 includes child-resistant features to prevent a child from removing lid 50 from body 14. In some embodiments, removal of lid 50 requires a patient to push down and rotate relative to body 14. In some embodiments, removal of lid 50 requires a patient to squeeze opposite sides of surface 56 and rotate lid 50 relative to body 14. In some embodiment, removal of lid 50 requires a patient to rotate lid 50 relative to body 14 to align notches (not shown) on lid 50 and body 14 and then pull lid 50 from body 14. In some embodiments, lid 50 is provided with instructions to aid a patient in removal from body 14. The instructions may be presented in the form of a graphic, such as, for example, an arrow with a lock, or text, such as, for example, “press down and turn”. In some embodiments, the instructions may be printed onto lid 50.

In some embodiments, medication 24 can include, such as, for example, a chewable tablet, quick dissolve tablet, effervescent tablet, reconstitutable powder, elixir, liquid, solution, suspension, emulsion, tablet, multi-layer tablet, bi-layer tablet, capsule, soft gelatin capsule, hard gelatin capsule, caplet, lozenge, chewable lozenge, bead, powder, granules, dispersible granules, cachets, douche, suppository, cream, topical, inhalant, aerosol inhalant, patch, particle inhalant, implant, depot implant, dragee, ampoule, ingestible, injectable, infusion, health bar, liquid, food, nutritive food, functional food, yogurt, gelatin, cereal, cereal coating, animal feed and/or combinations thereof.

In some embodiments, a dose of medicament, medication or drug may comprise vitamin A, B vitamins, vitamin C, vitamin D, vitamin E, vitamin K, essential fatty acids, folic acid, iron, calcium, magnesium, potassium, copper, chromium, zinc, molybdenum, iodine, boron, selenium, manganese, derivatives thereof and/or combinations thereof. In some embodiments, biologically-active substances may include thiamin, thiamin pyrophosphate, riboflavin, flavin mononucleotide, flavin adenine dinucleotide, niacin, nicotinic acid, nicotinamide, niacinamide, nicotinamide adenine dinucleotide, tryptophan, biotin, pantothenic acid, ascorbic acid, retinal, retinal, retinoic acid, beta-carotene, 1,25-dihydroxycholecalciferol, 7-dehyrdocholesterol, alpha-tocopherol, tocopherol, tocotrienol, menadione, menaquinone, phylloquinone, naphthoquinone, calcium, calcium carbonate, calcium sulfate, calcium oxide, calcium hydroxide, calcium apatite, calcium citrate-malate, calcium gluconate, calcium lactate, calcium phosphate, calcium levulinate, phosphorus, potassium, sulfur, sodium, docusate sodium, chloride, magnesium, magnesium stearate, magnesium carbonate, magnesium oxide, magnesium hydroxide, magnesium sulfate, copper, iodine, zinc, chromium, molybdenum, carbonyl iron, ferrous fumarate, polysaccharide iron, and/or combinations and derivatives thereof.

In some embodiments, a dose of medicament, medication or drug may be prescription and/or non-prescription substances. In some embodiments, the prescription substance may be a hormone replacement agent, a contraceptive agent, an osteoporotic agent, a chemotherapeutic agent, an anti-infective agent, analgesic, a steroid, an appetite suppressant, a weight loss agent, a tobacco antagonist, a cholesterol reducer and/or combinations thereof.

In some embodiments, the prescription substances may include, such as, for example, erythromycin, penicillins, cephalosporins, theophylline, albuterol, terbutaline, diltiazem, propranolol, nifedepine, clonidine, thioridazine, diazepam, meclizine, ergoloid mesylates, chlorpromazine, carbidopa, levodopa, beclomethasone diproprionate, budesonide, dexamehasone, flunisolide, fluticasone proprionate, mometasone furoate, triamcinolone acetonide, beconase, pulmicort, rhinocort, decadron, aerobid/nasolide, flovent/flonase, azmacort, amprenavir, adefovir dipivoxil, zidovudine, azidothymidine, AZT, paclitaxel, cyclophosphamide, teniposide, taxol, cytoxan, vumon, methotrexate, methotrexate, cisplatin, carboplatin, oxaliplatin, platinol, paraplatin, adriamycin, bleomycin, dactinomycin, daunorubicin, doxorubicin, indarubicin, mitomycin, blenoxane, cosmegen, cerubidine, rubex, indamycin, mutamycin, BCNU, streptozocin, vinblastine, thiotepa, conjugated estrogens, esterified estrogens, estropipate, estradiol, ethinyl estradiol, medroxyprogesterone, meprobamate, desogestrel, levonorgestrel, norethindrone, norethindrone acetate, norgestimate, norgestrel, raloxifene, tamoxifen, methyltestosterone, quinapril, losartan, sotalol, alendronate, atorvastatin, colestipol, clofibrate, and/or combinations thereof.

In some embodiments, the non-prescription substance can be a vitamin or derivative thereof, and/or a mineral compound or derivative thereof. In some embodiments, the vitamin or mineral compound may be, such as, for example, thiamin, thiamin pyrophosphate, riboflavin, flavin mononucleoride, flavin adenine dinucleotide, niacin, nicotinic acid, nicotinamide, niacinamide, nicotinamide adenine dinucleotide, tryptophan, biotin, folic acid, pantothenic acid, ascorbic acid, retinal, retinal, retinoic acid, beta-carotene, 1,25-dihydroxycholecalciferol, 7-dehydrocholesterol, alpha-tocopherol, tocopherol, tocotrienol, menadione, menaquinone, phylloquinone, naphthoquinone, calcium, calcium carbonate, calcium sulfate, calcium oxide, calcium hydroxide, calcium apatite, calcium citrate-malate, calcium gluconate, calcium lactate, calcium phosphate, calcium levulinate, phosphorus, potassium, sulfur, sodium, docusate sodium, chloride, magnesium, magnesium stearate, magnesium carbonate, magnesium oxide, magnesium hydroxide, magnesium sulfate, copper, iodine, zinc, chromium, molybdenum, carbonyl iron, ferrous fumarate, polysaccharide iron, and combinations and derivatives thereof. In some embodiments, the derivatives of vitamin compounds include salts, alkaline salts, esters and chelates of any vitamin compound. In some embodiments, the nonprescription substance can be a herbal compound, herbal extract, derivative thereof and/or combinations thereof.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A medication container comprising:
a body including a wall that defines a cavity configured for disposal of medication, the wall defining a gap; and
indicia disposed with gap,
wherein the indicia is configured to facilitate visualization of the medication disposed within the cavity.

2. A medication container as recited in claim 1, wherein the body includes a first color and the indicia includes a second color.

3. A medication container as recited in claim 2, wherein the first color is blue.

4. A medication container as recited in claim 2, wherein the second color includes yellow.

5. A medication container as recited in claim 2, wherein the second color includes amber.

6. A medication container as recited in claim 1, wherein the indicia includes a transparent material.

7. A medication container as recited in claim 1, wherein the indicia includes a view stripe.

8. A medication container as recited in claim 1, wherein the indicia includes a coating configured to prevent light and/or oxygen from passing therethrough.

9. A medication bottle comprising:
a body including a wall defining a cavity configured for disposal of a medication, the body defining a gap and including a blue surface color; and
a view stripe disposed with the gap and including a yellow surface color,
wherein the view stripe is configured to facilitate visualization of the medication disposed within the cavity.

10. A medication packaging system comprising:
a medication packaging container comprising a body including a wall defining a cavity and indicia disposed along the body, the body defining a gap;
at least one dose of medication disposed within the cavity;
a view stripe disposed with the gap and longitudinally along the body, the view stripe being configured to facilitate visualization of the medication disposed within the cavity; and
a lid configured for engagement with a portion of the body to enclose the medication within the cavity.
